(19) United States
(12) Patent Application Publication
(10) Pub. No.: US 2010/0206279 A1
(43) Pub. Date: Aug. 19, 2010

(54) METHOD AND APPARATUS FOR OPTIMIZATION OF OPERATION AND SUPPLY OF TWO-STROKE ENDOTHERMIC ENGINES, PARTICULARLY TO BE EMPLOYED IN THE INDUSTRIAL SECTOR RELEVANT TO MICROENGINES IN THE HOBBY-MODELLISTIC FIELD

(76) Inventor: Giorgio Grossi, Rome (IT)

Correspondence Address: GAUTHIER & CONNORS, LLP, 225 FRANKLIN STREET, SUITE 2300, BOSTON, MA, 02110, US

(21) Appl. No.: 12/731,300

(22) Filed: Mar. 25, 2010

Related U.S. Application Data
(63) Continuation of application No. PCT/IT2008/000648, filed on Oct. 16, 2008.

(30) Foreign Application Priority Data
Oct. 17, 2007 (IT) RM2007A000545

(51) Int. Cl. F02B 25/00

(52) U.S. Cl. 123/65 V

(57) ABSTRACT

The invention concerns a method and an apparatus for optimization of operation and supply of two-stroke endothermic engines, particularly to be employed in the industrial sector relevant to micro engines in the hobby-modellistic field, so as to obtain an improvement of known two-stroke endothermic engines with suction by rotating disc valve, thanks to the use of methods permitting obtaining a better general efficiency of engine, thus obtaining lower consumption along with a better volumetric efficiency and a better mechanical efficiency.

### PRIORITY INFORMATION

The present application claims priority to International Patent Application No. PCT/IT2008/000648 filed on Oct. 16, 2008 which claims priority to Italian Patent Application No. RM2007A000545, filed on Oct. 17, 2007, all of which are incorporated herein in their entirety.

### BACKGROUND OF THE INVENTION

The present invention relates to a method and an apparatus for optimization of operation and supply of two-stroke endothermic engines, particularly to be employed in the industrial sector relevant to micro engines in the hobby-modellistic field.

More specifically, the invention essentially consists in improvement of known two-stroke endothermic engines, with a suction by a rotating disc inlet valve, thanks to the application of methods permitting obtaining a better general efficiency of engine, lower consumption along with a better volumetric efficiency and a better mechanical efficiency.

### SUMMARY OF THE INVENTION

Operation of engine according to the present invention is that typical of known two-stroke engines with suction from carter-pump and controlled flow from a rotating valve.

It is therefore specific object of the present invention an apparatus as claimed in the enclosed claim 1.

Further embodiments are described and claimed in the dependent claims.

### BRIEF DESCRIPTION OF THE DRAWINGS

The present invention will be now described, for illustrative and not limitative purposes, according to its preferred embodiments, with particular reference to the figures of the enclosed drawings, wherein:

FIG. 1 is a section view of an engine according to the invention;

FIG. 2 shows a plan view of discs comprising the inlet valve for supply flow;

FIG. 3 shows a particular of sealing coupling of piston and cylinder of engine of apparatus according to the invention;

FIG. 4 is an exploded view of a particular of a second embodiment of the apparatus according to the invention; and

FIG. 5 is an exploded view of a particular of a third embodiment of the apparatus according to the invention.

### DETAILED DESCRIPTION OF THE INVENTION

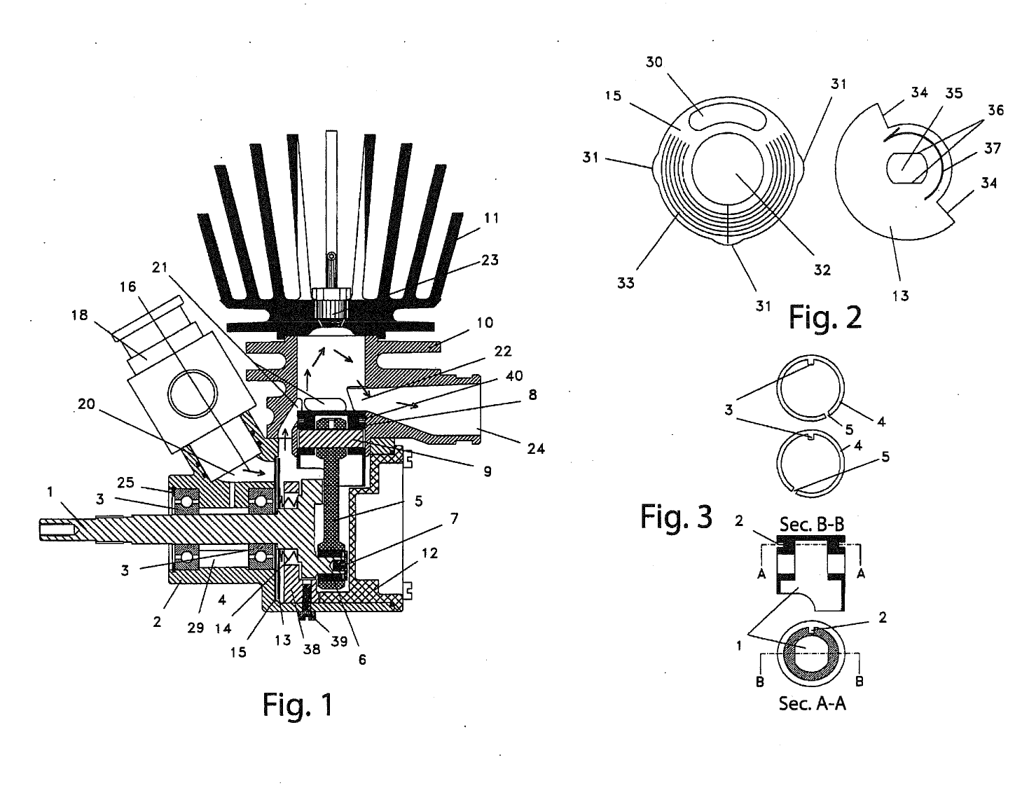

Observing first FIG. 1, it is shown a section of an engine, specifically an engine suitable for modellistic field (cars, airplanes, ecc.), representing one of the possible applications, wherein components are those already known, such as output shaft 1, connecting rod 5, piston pin 9, piston 8, cylinder 10, head 11, spark-plug 23, carburetor 18, carter 2, rear carter plug 12, output shaft bearing 2, oil reservoir for bench bearings 29, bench bearing stop 25, mixture oil recovery channel 4, ecc.

Operation occurs for the above components, according to the known two-stroke engine operation, with the exception of rotating disc inlet valve for supply flow (that will be described in greater detail in the following), realized by an innovative method, also fixing of connecting rod to the output shaft and piston ring seal being realized by an innovative method.

In the exemplificative apparatus shown in FIGS. 1 and 2, rotating valve is comprised in an new way within the carter-pump 2, and according to the direction of the motion drive of output shaft 1. Said rotating valve is comprised of disc 15, fixed and integral with carter 2, and of rotating disc 13, integral with movement of shaft 1. Particulars 13 and 15 of FIG. 1 are shown sectioned mounted on engine, while in FIG. 2 are singularly shown on the plane.

Supply flow of engine with suction from carter 2 passes through carburetor 18 within conduct 20, wherein it is positioned fixed disc 15, with opening 30 of FIG. 2 in a position corresponding to suction conduct of FIG. 1. Rotating disc 13 rests on fixed disc 15, and is moved by output shaft 1 shown in FIG. 1, to which is fixedly coupled by planes shown in FIG. 2, having the suitable shape also provided on shaft 1; said disc 13 induces, when rotating according to direction indicated by arrow 37 of FIG. 2, opening and closure of passage 30 of flow, thus realizing within carter the same control of rotation of disc 13 on disc 15, opening and closing the phase by parts 34 shown in FIG. 2.

Rotating disc 13 is kept adhering to fixed disc 15 by thrust of elastic device 34 (see FIG. 1), which integrally rotate with output shaft of FIG. 1. Lubrication of valve according to the invention is obtained by oil contained within mixture supplying engine.

As it can be observed in FIG. 1, thickness 38, blocked by screw 39, is inserted within carter in order to limit the so called noxious volume. Fixed disc 15 (see FIG. 2) provides suitable projections 31, blocking the same carter 2, having the same shape to house it thus preventing rotation of disc 15 due to adhesion rotation to the same rotating disc 13.

Connecting rod 5 is constrained to output shaft 1 by a new method providing the use of a stop screw 7, which, being screwed on shaft 1, prevents axial exit of rotating connecting rod 5 on output shaft, with interposition of a roll bearing 6, being thus possible realizing shafts opens toward connecting rod 5, thus permitting the use of roll bearing in connecting rod and possibility of constraining shaft only by a pair of bearings positioned on a single side of the output shaft.

Sealing of piston 8 within cylinder 10 is realized by a new method shown in FIG. 3, wherein it is possible observing that elastic sealing rings 4 are equal, but symmetric, with respect to the position of cuts 5; this permits that, overlapping the same, there is no coincidence of the open points 5 of sealing segments 4, thus causing closure of juxtaposition of the same in correspondence of discontinuity points 5. Segments 4 are mounted each other within cavity 2 on piston 1, and on the same piston it is realized housing corresponding to fixing projection 3 of piston 1 obtained on piston rings 4. Said projections 3, entering within cavity 2, prevent rotation of ring 4 about piston 1, during operation of engine.

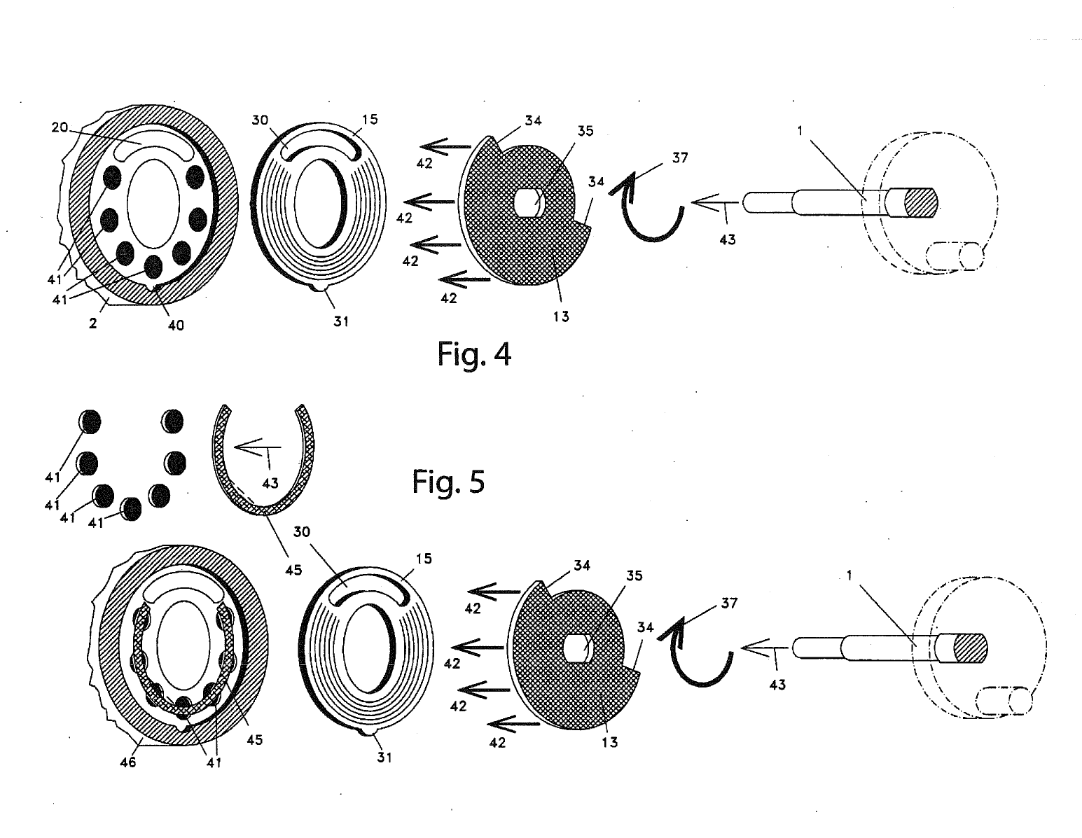

Observing now FIGS. 4 and 5, it is noted that elastic device 14 can be replaced obtaining adhesion of rotating disc 13 on fixed disc 15 by the use of a magnetic field attracting rotating disc 13, said disc being comprised of ferromagnetic material sensitive to magnetic field in the direction of fixed disc 15. Particularly, apparatus shown in FIGS. 4 and 5 provides a series of calamite 41, integrally provided within carter 2. On the front portion of the same calamite 41 it is provided fixed disc 15, on which rotating disc 13 adhering to fixed disc 15 rotates by output shaft 1. Said disc 13 is kept adhering to the fixed disc 15 by magnetic field created by calamite 41 and is attracted according to the arrows 42. Both carter 2 and fixed disc 15 are comprised of materials not sensitive to the magnetic field created by calamite 41. Apparatus of FIG. 5 is realized with the front insertion of calamite 41 within body 45, the latter being comprised of material sensitive to magnetic field. Said body 45 permits distributing magnetic field created by calamite 41 in a uniform way on rotating disc 13, making all calamite cooperating with respect to every angular position taken during the rotation of disc 13.

Summarizing, method described in the above permits obtaining uniform adhesion of rotating disc 13 with disc 15 independently from number of revolutions per minute of the same disc.

Apparatus shown in the figures is suitable for an application in the modellistic field (mini cars, airplanes, ecc.) up to 15 cc. In this application, innovative solution never applied to the field of the two stroke engines for modellistic use have been introduced, such as the rotating valve, for inlet of supply flow, which is not only inside carter but is also provided on the outlet side of the output shaft with respect to the carter; also connecting rod is mounted according to an innovative method, thus rotating on shaft by roll bearing with a stop screw on the same shaft.

It is further realized oil reservoir separated from the carter by bench bearings; cylinder is comprised of a single cast piece without barrels and is surface treated inside by suitable materials such as “NICASIL” and like. These innovative solutions are specifically suitable for two stroke endothermic engines.

Present invention has been described for illustrative and not limitative purposes with reference to preferred embodiments, but it is understood that variations and/or modifications can be introduced without departing from the relevant scope defined in the enclosed claims.

What is now claimed:

1. An apparatus for optimization of operation and supply of two-stroke endothermic engines, particularly to be employed in the industrial sector relevant to micro engines in the hobby-modellistic field, said apparatus providing a rotating disc valve for adjusting inlet of supply flow within the carter, said valve being provided inside said engine carter and on the side of the output shaft drive, wherein rotating disc valve for adjustment of inlet of flow within carter is provided within the same carter and on the output shaft drive side, the same rotating valve being maintained adhering to the not rotating part by a magnetic field suitably created by magnets, in that rotating part of carter flow adjustment valve is comprised of material sensitive to the magnetic field being attracted to the fixed part on which it rotates by suitable calamite inserted within carter, adherence between the rotating part, sensitive to the magnetic field, and another fixed part being realized by employing a magnetic field able maintaining coupled said parts during the rotation independently from the number of revolution per minute.

2. The apparatus according to claim 1, wherein fixed disc of the rotating valve is obtained by a suitable working directly on the carter.

3. The apparatus according to claim 1, wherein elastic element maintaining rotating disc adhering to the fixed disc during its rotation is comprised of two elastic elements, such as “V-ring” or like, eventually coupled with elastic rings, such as “O-ring” for containing centrifugal forces.

4. (canceled)

5. The apparatus according to claim 1, wherein engine cylinder is comprised of a single casting then subjected to an inner surface treatment, such as “NICASIL” or similar anti-abrasion lining without adding a separated barrel.

6. The apparatus according to claim 1, wherein control of carter sucking is obtained by a rotating disc within the carter on the said of the output shaft power drive.

7. The apparatus according to claim 1, wherein reservoir is realized separated with respect to the carter, said reservoir containing oil for lubricating bench bearings, with provision of oil sealing oil retainer acting on the output shaft, suitably maintained by a stop open ring.

8. The apparatus according to claim 1, wherein connecting rod rotates on the shaft by a suitable roll bearing, and it is kept on the same shaft by a suitable roll bearing and is kept within the seat by a suitable screw screwed on the same shaft in correspondence of the axis of the roll bearing of the connecting rod.

9. The apparatus according to claim 1, wherein adjustment of idling is realized by an adjustment screw outside the carburetor body.

10. The apparatus according to claim 1, wherein fixed disc on which rotating disc comprising the carter suction valve rotates is fixed to the carter by complementary fins obtained on the same disc and on the carter, in order to prevent rotation of fixed disc following rotation of rotating disc.

11. The apparatus according to claim 1, wherein output shaft is provided with a so called “full abutment” provided on the shaft in order to reduce the so called “noxious volume” of carter-pump and to increase flow inlet pressure during the suction transfer.

12. The apparatus according to claim 1, wherein output shaft has, on the outer exit of the front bearing, a slightly reduced diameter in correspondence of the end of the bearing, said reduced diameter permitting realizing stop abutment when coupling drives, such as frictions and like, are tightened on the engine, said system preventing axial tightening of engine bench bearings.

13. The apparatus according to claim 1, wherein double elastic sealing rings are provided on the cylinder, so as to be used juxtaposed without that the open part of the same overlaps, constrained not to rotate on the piston with a suitable projection inserted within the suitable cavity realized on piston.

14. The apparatus according to claim 1, wherein “SEEGER” rings are employed on piston.

15. The apparatus according to claim 1, wherein forced circulation liquid cooling by pump and heat exchanging radiator is employed for realizing micro engines for hobby-modellistic use up to 3.8 cc.

16. The apparatus according to claim 1, wherein double elastic sealing rings are provided on cylinder such as to be employed juxtaposed, without juxtaposition of the open part, said rings not rotating on piston.

17-19. (canceled)
